(19) United States
(12) Patent Application Publication
(10) Pub. No.: US 2020/0353701 A1
(43) Pub. Date: Nov. 12, 2020

(54) Fiber Reinforced Resin Structure and Method Of Manufacturing The Same

(71) Applicant: Suzuki Motor Corporation, Hamamatsu-shi (JP)

(72) Inventors: Kyohei Ikoma, Hamamatsu-shi (JP); Daisuke Hatano, Hamamatsu-shi (JP); Kenta Suzuki, Hamamatsu-shi (JP)

(73) Assignee: Suzuki Motor Corporation, Hamamatsu-shi (JP)

(21) Appl. No.: 16/861,743

(22) Filed: Apr. 29, 2020

(30) Foreign Application Priority Data
May 8, 2019 (JP) 2019-088410

(51) Int. Cl. B29C 70/30

(52) U.S. Cl. CPC B29C 70/30

(57) ABSTRACT

The present invention relates to a fiber reinforced resin structure having a through-hole. The structure includes an inner resin portion forming a peripheral edge portion of the through-hole, and an outer resin portion adjacent to an outer peripheral edge of the inner resin portion. The inner resin portion is formed by a matrix resin. The outer resin portion includes base material sheets formed of a fiber reinforced resin having fiber and the matrix resin. The base material sheets are stacked together in the thickness direction of the structure. The inner and outer resin portions are formed integrally so as to be continuous with each other by the matrix resin. The present invention also relates to a method of manufacturing the structure.

### CROSS-REFERENCE TO RELATED APPLICATIONS

This application claims the benefit of the filing date of Japanese Patent Application No. 2019-088410, filed on May 8, 2019, the disclosure of which is hereby incorporated herein by reference.

### BACKGROUND OF THE INVENTION

### Technical Field

The present invention relates to a fiber reinforced resin structure having a through-hole. The present invention also relates to a method of manufacturing a fiber reinforced resin structure having a through-hole.

### Background Art

A fiber reinforced resin structure formed by using a fiber reinforced resin, may be employed in a mechanical structure, in particular, a vehicle, such as a motorcycle, an automobile, or the like. A fiber reinforced resin is lightweight and has high strength, and thus, a fiber reinforced resin structure using these qualities, is adopted in a portion in which a reduction in weight and an improvement in terms of strength are required.

In the case in which a through-hole is to be provided in such a fiber reinforced resin structure, an operator practices a molding process in which a molding formed of a fiber reinforced resin is prepared through molding, and a drilling process in which the drilling processing is performed on the molding by using a drilling tool, such as a drill or the like. However, the fiber reinforced resin has high hardness, and the drilling processing on such molding takes a lot of time. Furthermore, the drilling tool is subject to wear. This drilling processing has low efficiency, that is to say, production efficiency of the fiber reinforced resin structure having a through-hole, is low.

Thus, a fiber reinforced resin structure manufacturing technique for solving these problems, has been proposed. In an example of such a manufacturing technique, in the molding process, the portion to be drilled of the structure (molding) after molded, is pressed between a protrusion provided on one of the upper die and the lower die so as to correspond to this portion to be drilled, and a recess provided in the other of the upper die and the lower die so as to correspond to the portion to be drilled, whereby continuous fiber is moved from the portion to be drilled to the periphery of this portion to be drilled, and then, in the drilling process, the drilling processing is performed on the portion to be drilled (See, for example, JP 2017-132085 A).

### BRIEF SUMMARY OF THE INVENTION

### Problems to be Solved by the Invention

However, in the above-described example of the fiber reinforced resin structure manufacturing technique, continuous resin is still allowed to exist at the portion of the molding to be drilled. Thus, the hardness involved in the drilling processing is still high, and a lot of time must still be spent on the drilling processing of the molding. Furthermore, the drilling tool is still subject to wear. As a result, efficiency of the drilling processing is as low as ever, that is to say, the manufacturing efficiency of the fiber reinforced resin structure having a through-hole, is as low as ever. Eventually, the drilling processing still constitutes a factor leading to an increase in processing cost.

In the above-described example of the fiber reinforced resin structure manufacturing technique, for example, the condition of forming the protrusion and the recess so as to allow movement of continuous fiber in the molding, the condition of setting the position, size, range, thickness, etc. of the portion to be drilled so as to allow movement of the continuous fiber, and/or the like, must be satisfied. As a result, the manufacturing conditions for the fiber reinforced resin structure are significantly restrictive. Thus, the manufacturing efficiency of the fiber reinforced resin structure having a through-hole, is low.

In the above-described example of the fiber reinforced resin structure manufacturing technique, in the molding process, the difference in density between the portion of high continuous resin density and the portion of low continuous resin density, is large in the periphery of the portion to be drilled. As a result, stress concentration is likely to be generated at the peripheral edge portion of the through-hole after the drilling processing. Thus, the strength of the fiber reinforced resin structure may be reduced.

In the above-described example of the fiber reinforced resin structure manufacturing technique, in many cases, the fiber reinforced resin structure is used in a state in which a metal fastening member is inserted into the through-hole. For example, in the case in which the fiber contained in the fiber reinforced resin structure, is carbon fiber, the metal fastening member in contact with the peripheral edge portion of the through-hole of the fiber reinforced resin structure containing carbon fiber, is subject to electrical erosion. Thus, the strength of the fiber reinforced resin structure which is formed such that a metal fastening member is inserted into the through-hole of the fiber reinforced resin structure, may be reduced.

In view of these circumstances, in the fiber reinforced resin structure and the method of manufacturing the same, it is desired that the manufacturing efficiency of the fiber reinforced resin structure having a through-hole be enhanced, and a reduction in the strength of the fiber reinforced resin structure be efficiently suppressed.

### Solution to Problem

To solve the above problems, a fiber reinforced resin structure according to an aspect is a fiber reinforced resin structure having a through-hole, the fiber reinforced resin structure including: an inner resin portion forming a peripheral edge portion of the through-hole; and an outer resin portion arranged so as to be adjacent to an outer peripheral edge of the inner resin portion, wherein the inner resin portion is formed by a matrix resin, the outer resin portion includes a plurality of base material sheets formed of a fiber reinforced resin having fiber and the matrix resin, the plurality of base material sheets are stacked together in a thickness direction of the fiber reinforced resin structure, and the inner and outer resin portions are formed integrally so as to be continuous with each other by the matrix resin.

To solve the above problems, a method of manufacturing a fiber reinforced resin structure having a through-hole according to an aspect is a method of manufacturing a fiber reinforced resin structure having a through-hole, the method including: a stacking step of stacking together a plurality of base material sheets so as to make a temporary through-hole extending through the plurality of base material sheets continuous in a thickness direction of the fiber reinforced resin structure, the base material sheets being formed of a fiber reinforced resin having fiber and a matrix resin; a molding step of molding the plurality of base material sheets stacked together while forming an inner resin portion which covers a peripheral edge of the temporary through-hole of the plurality of base material sheets stacked together and is formed of the matrix resin; and a hole shaping step of shaping the through-hole such that the through-hole extends through the inner resin portion.

### Advantageous Effect of Invention

In the fiber reinforced resin structure and the method of manufacturing the same according to an aspect, manufacturing efficiency of the fiber reinforced resin structure having a through-hole, can be improved, and a reduction in the strength of the fiber reinforced resin structure can be suppressed efficiently.

### BRIEF DESCRIPTION OF THE DRAWINGS

FIG. 1 is a perspective view schematically showing a fiber reinforced resin structure according to an Embodiment.

FIG. 2 is a perspective view schematically showing the fiber reinforced resin structure according to the Embodiment, in a state in which a bolt is inserted into a through-hole thereof.

FIG. 3 is a sectional view taken along line A-A of FIG. 2.

FIG. 4 is a sectional view schematically showing a cross section of the fiber reinforced resin structure according to the Embodiment, which is taken along a line corresponding to line A-A of FIG. 2, in a state in which a bolt is inserted into the through-hole thereof, the bolt is threadedly engaged with a nut, and another member is held between the nut and the fiber reinforced resin structure.

FIG. 5 is a perspective view schematically showing the stacking step of the fiber reinforced resin structure manufacturing method according to the Embodiment, in a state before a plurality of base material sheets are stacked together.

FIG. 6 is a sectional view schematically showing cross sections of a plurality of base material sheets stacked together, which are taken along a line corresponding to line A-A of FIG. 2, in the stacking step of the fiber reinforce resin structure manufacturing method according to the Embodiment.

FIG. 7 is a sectional view schematically showing a cross section of molding after molded, which is taken along a line corresponding to line A-A of FIG. 2, in the molding step of the fiber reinforced resin structure manufacturing method according to the Embodiment.

FIG. 8 is a sectional view schematically showing a cross section of the fiber reinforced resin structure with a through-hole formed therein, which is taken along a line corresponding to line A-A of FIG. 2, in the hole shaping step of the fiber reinforced resin structure manufacturing method according to the Embodiment.

### DETAILED DESCRIPTION

A fiber reinforced resin structure and a method of manufacturing the same according to an Embodiment will be described as follows. In the present Embodiment, the fiber reinforced resin structure (hereinafter simply referred to as the “structure” as needed) is formed so as to have a through-hole. The fiber reinforced resin material used in the structure according to the present Embodiment, contains a matrix resin and fiber.

As the matrix resin, it is possible to use a thermoplastic resin, a thermosetting resin, or the like. As the thermoplastic resin, it is possible to use, for example, polyamide, polypropylene, or the like. As the thermosetting resin, it is possible to use, for example, epoxy resin, phenol resin, or the like.

In the fiber reinforced resin material, at least one of a continuous fiber reinforced resin or a discontinuous fiber reinforced resin is used. The fiber may be carbon fiber, glass fiber, polyamide fiber, polyethylene fiber, or the like. In the case in which the fiber reinforced resin material is a discontinuous fiber reinforced resin material, in the view of the reinforcing effect, the length of a single fiber may be 10 mm or more. However, the length of a single fiber is not limited thereto.

### Outline of Fiber Reinforced Resin Structure

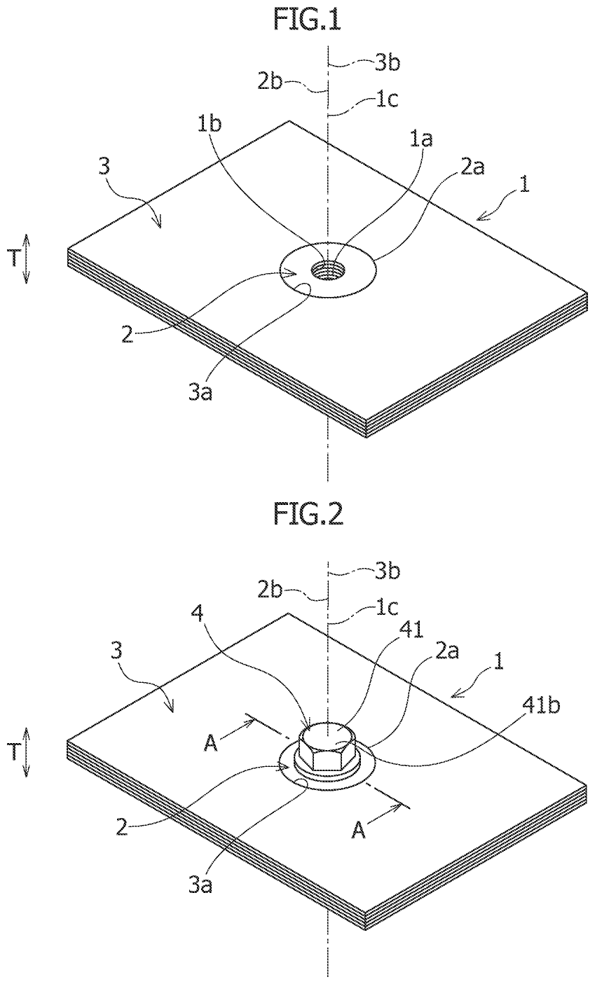

First, an outline of a fiber reinforced resin structure 1 according to the present Embodiment will be described with reference to the FIGS. 1 to 4. As shown in FIG. 1, the structure 1 has a through-hole 1a as described above. As shown in FIGS. 1 to 4, the structure 1 has an inner resin portion 2 forming a peripheral edge portion 1b of the through-hole 1a. Furthermore, the structure 1 has an outer resin portion 3 arranged so as to be adjacent to an outer peripheral edge 2a of the inner resin portion 2.

The inner resin portion 2 is formed of a matrix resin. The outer resin portion 3 includes a plurality of base material sheets 31, 32, 33, 34, and 35 formed of fiber and a fiber reinforced resin including the matrix resin. FIGS. 1 to 4 show, by way of example, a case in which the outer resin portion 3 includes the five base material sheets 31 to 35, that is to say, the first base material sheet 31, the second base material sheet 32, the third base material sheet 33, the fourth base material sheet 34, and the fifth base material sheet 35. It should be noted, however, that the outer resin portion can include two, three, four, or six or more base material sheets. That is to say, the outer resin portion can include first to nth base material sheets. Here, n is an integer of two or more.

The plurality of base material sheets 31 to 35 are stacked together in the thickness direction (indicated by arrow T) of the structure 1. The inner and outer resin portions 2 and 3 are integrally formed of a matrix resin so as to be continuous with each other.

Furthermore, the outline of the fiber reinforced resin structure 1 may be configured as follows. As shown in FIGS. 2 to 4, the inner resin portion 2 has a thickness direction contact region (contact region) C1 coming into contact with a metal element 4 inserted into the through-hole 1a, in the thickness direction of the structure 1. The metal element 4 will be described in detail below. The inner resin portion 2 has end portions 21 and 22 respectively situated at both end portions in the thickness direction of the structure 1, that is to say, one end portion 21 and the other end portion 22. Furthermore, the inner resin portion 2 has an intermediate portion 23 situated between the end portions 21 and 22 of the inner resin portion 2 in the thickness direction of the structure 1.

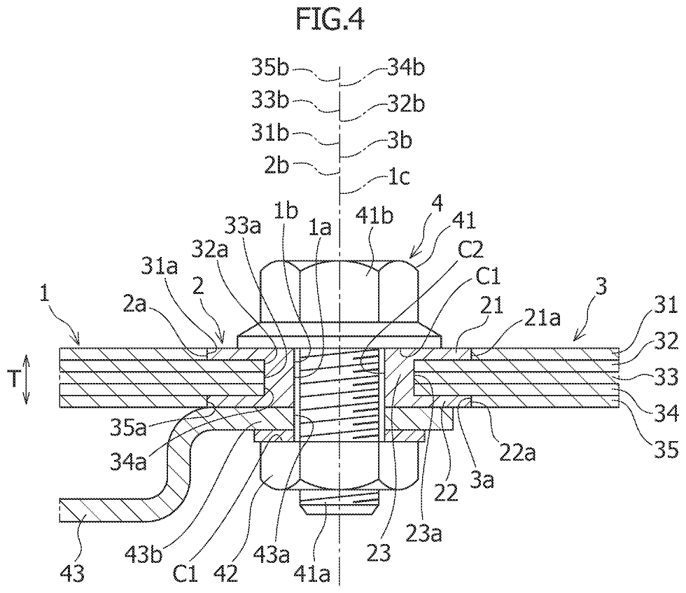

The outer peripheral edge 21a, 22a of at least one of both end portions 21 and 22 of the inner resin portion 2 is formed to be larger than the outer peripheral edge 23a of the intermediate portion 23 of the inner resin portion 2. FIG. 4 shows, by way of example, the case in which the outer peripheral edge 21a, 22a of both end portions 21 and 22 of the inner resin portion 2 is formed to be larger than the outer peripheral edge 23a of the intermediate portion 23 of the inner resin portion 2. However, it is also possible to form the outer peripheral edge of only one of both end portions of the inner resin portion to be formed larger than the outer peripheral edge of the intermediate portion of the inner resin portion.

### Details on Fiber Reinforced Resin Structure

Furthermore, in detail, the fiber reinforced resin structure 1 may be configured as follows. Referring to FIGS. 1 to 4, a cross section of the through-hole 1a of the structure 1 is formed in a substantially circular shape. Each of the one end portion 21, the other end portion 22, and the intermediate portion 23 of the inner resin portion 2 is formed in a substantially disc shape. Each of the one end portion 21, the other end portion 22, and the intermediate portion 23 of the inner resin portion 2 may be formed in a substantially disc shape such that the center thereof is substantially the center axis 2b of the inner resin portion 2. The center axis 1c of the through-hole 1a and the center axis 2b of the inner resin portion 2 may substantially coincide with each other. The through-hole 1a may extend through the inner resin portion 2 such that the center axis 1c thereof and the center axis 2b of the inner resin portion 2 substantially coincide with each other.

The plurality of base material sheets 31 to 35 of the outer resin portion 3 consist of one end side base material sheet 31 and the other end side base material sheet 35 respectively situated at one end and the other end in the thickness direction of the structure 1, and intermediate base material sheets 32 to 34 situated between the one and the other end side base material sheets 31 and 35. However, in the case in which the outer resin portion includes two base material sheets, the two base material sheets consist solely of the one and the other end side base material sheets.

In other words, in the case in which the outer resin portion is formed by using first to nth base material sheets (n is an integer of two or more), the first to nth base material sheets are stacked together, in that order, from one side toward the other side in the thickness direction of the structure 1, as described above. Furthermore, in the case in which n is an integer of three or more, the first base material sheet is defined as the one end side base material sheet, the second base material sheet or the second to (n−1)th base material sheet are defined as the intermediate base material sheets, and the nth base material sheet is defined as the other end side base material sheet.

In FIGS. 1 to 4, the first to fifth base material sheets 31 to 35 of the outer resin portion 3 are stacked together, in that order from, one side toward the other side in the thickness direction of the structure 1. In this case, the first base material sheet 31 is defined as the one end side base material sheet 31, the second to fourth base material sheets 32 to 34 are defined as the intermediate base material sheets 32 to 34, and the fifth base material sheet 35 is defined as the other end side base material sheet 35. However, the base material sheets of the outer resin portion are not limited to those shown in the drawings.

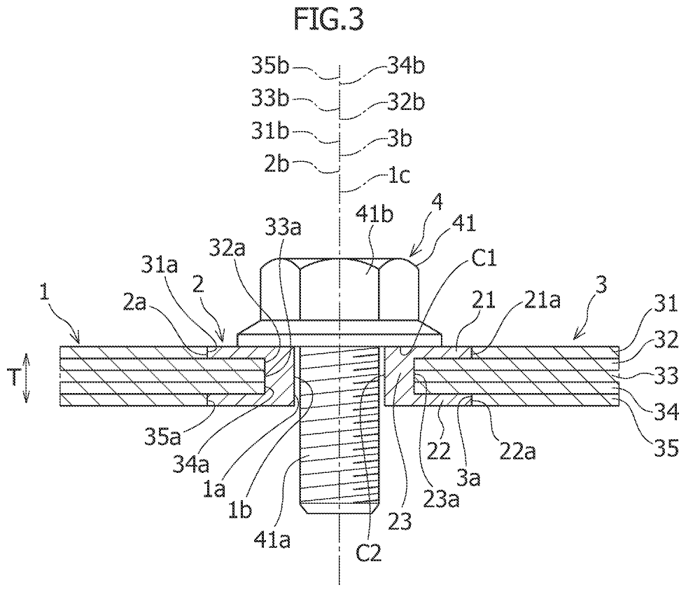

As shown in FIGS. 3 and 4, the outer resin portion 3 may be formed by the plurality of base material sheets 31 to 35. The outer resin portion 3 has an inner peripheral edge 3a adjacent to the outer peripheral edge 2a of the inner resin portion 2. Furthermore, the one end side base material sheet 31 has an inner peripheral edge 31a adjacent to the outer peripheral edge 21a of the one end portion 21 of the inner resin portion 2. The intermediate base material sheets 32, 33, and 34 respectively have inner peripheral edges 32a, 33a, and 34a adjacent to the outer peripheral edge 23a of the intermediate portion 23 of the inner resin portion 2. The other end side base material sheet 35 has an inner peripheral edge 35a adjacent to the outer peripheral edge 22a of the other end portion 22 of the inner resin portion 2.

The inner peripheral edge 3a of the outer resin portion 3 is formed so as to correspond to the outer peripheral edge 2a of the inner resin portion 2. The inner peripheral edge 31a of the one end side base material sheet 31 is formed so as to correspond to the outer peripheral edge 21a of the one end portion 21 of the inner resin portion 2. The inner peripheral edges 32a to 35a of the intermediate base material sheets 32 to 35 are formed so as to correspond to the outer peripheral edge 23a of the intermediate portion 23 of the inner resin portion 2. The inner peripheral edge 35a of the other end side base material sheet 35 is formed so as to correspond to the outer peripheral edge 22a of the other end portion 22 of the inner resin portion 2.

Each of the inner peripheral edge 31a of the one end side base material sheet 31, the inner peripheral edges 32a to 34a of the intermediate base material sheets 32 to 34, and the inner peripheral edge 35a of the other end side base material sheet 35 is formed in a substantially cylindrical shape. The inner peripheral edges 31a and 35a of the one and the other end side base material sheets 31 and 35 are formed to be larger than the inner peripheral edges 32a to 34a of the intermediate base material sheets 32 to 34. In the case in which the outer resin portion 3 has a plurality of intermediate base material sheets 32 to 34, the inner peripheral edges 32a to 34a thereof can be formed in a substantially equal size.

However, it is also possible to form the inner peripheral edge of solely one of the one and the other end side base material sheets to be larger than the inner peripheral edges of the intermediate base material sheets. In this case, the inner peripheral edge of the other of the one and the other end side base material sheets can be formed to be substantially equal to the inner peripheral edges of the intermediate base material sheets. Furthermore, in the case in which the outer resin portion has a plurality of intermediate base material sheets, the inner peripheral edge of at least one intermediate base material sheet can be formed in a size different from that of the inner peripheral edge of another intermediate base material sheet.

The center axis 3b of the inner peripheral edge 3a of the outer resin portion 3 substantially coincides with the center axis 2b of the inner resin portion 2. In the outer resin portion 3, the center axes 31b, 32b, 33b, 34b, and 35b of the inner peripheral edges 31a, 32a, 33a, 34a, and 35a of the one end side, the intermediate side, and the other end side base material sheets 31, 32, 33, 34, and 35 may substantially coincide with each other so as to constitute the center axis 3b of the inner peripheral edge 3a. Furthermore, each of the inner peripheral edges 31a to 35a of the one end side, the intermediate, and the other end side base material sheets 31 to 35 may be formed in a substantially cylindrical shape such that the center thereof is substantially the center axis 3b of the inner peripheral edge 3a of the outer resin portion 3.

The inner peripheral edge 3a of this outer resin portion 3 corresponds to the peripheral edge 3a of a temporary through-hole 3c of the outer resin portion 3 described below. Furthermore, the inner peripheral edges 31a, 32a, 33a, 34a, and 35a of the plurality of base material sheets 31, 32, 33, 34, and 35 respectively correspond to the peripheral edges 31a, 32a, 33a, 34a, and 35a of temporary through-holes 31c, 32c, 33c, 34c, and 35c described below.

As shown in FIGS. 2 to 4, the metal element 4 has a first member 41 inserted into the through-hole 1a of the structure 1. The first member 41 is a bolt 41. The bolt 41 has a male screw portion 41a inserted into the through-hole 1a. Furthermore, the bolt 41 has a head portion 41b situated at the proximal end side in the longitudinal direction of the male screw portion 41a. The outer periphery of the head portion 41b is larger than the outer periphery of the male screw portion 41a. However, the one end side member may be a member other than a bolt. For example, the metal element may be a screw, rivet, or the like.

The head portion 41b of the bolt 41 comes into contact with one end portion 21 of the inner resin portion 2 in the thickness direction of the structure 1. Thus, a thickness direction contact region C1 of the inner resin portion 2 includes the one end portion 21 of the inner resin portion 2.

As shown in FIG. 4, the metal element 4 further has a second member 42 which can be fastened to the first member 41. The second member 42 may be a nut 42 which can be threadedly engaged with the male screw portion 41a of the bolt 41. However, the second member is not limited to a nut.

Furthermore, the metal element 4 can further have a third member 43 which is held between the first and second members 41 and 42 together with the inner resin portion 2. The third member 43 is arranged so as to come into contact with the other end portion 22 of the inner resin portion 2 in the thickness direction of the structure 1. The third member 43 is a metal plate 43. The metal plate 43 has an insertion hole 43a extending therethrough so as to allow insertion of the male screw portion 41a of the bolt 41. The metal plate 43 further has a mounting portion 43b formed in the periphery of the insertion hole 43a so as to come into contact solely with the other end portion 22 of the inner resin portion 2 in the thickness direction of the structure 1. Thus, the thickness direction contact region C1 of the inner resin portion 2 can include the other end portion 22 of the inner resin portion 2 in addition to the one end portion 21 of the inner resin portion 2.

However, the third member may be a member other than a metal plate. For example, the other side member may be a metal washer, a metal sheet, a metal film, a metal block, or the like. Furthermore, instead of the first member, the third member can be arranged so as to come into contact with one end portion of the inner resin portion in the thickness direction of the structure. In this case, the metal element may have a fourth member which is arranged so as to come into contact with the other end portion of the inner resin portion in the thickness direction of the structure, or the second member may be arranged so as to come into contact with the other end portion of the inner resin portion in the thickness direction of the structure.

Furthermore, the male screw portion 41a of the bolt 41 can be brought into contact with the peripheral edge portion 1b of the through-hole 1a of the structure 1 in a planar direction substantially orthogonal to the thickness direction of the structure 1. That is to say, in a planar direction, the male screw portion 41a of the bolt 41 can come into contact with the inner resin portion 2 forming the peripheral edge portion 1b of the through-hole 1a, more specifically, the one end portion 21, the other end portion 22, and the intermediate portion 23 of the inner resin portion 2. Thus, the inner resin portion 2 can include a planar direction contact region C2 coming into contact, in the planar direction, with the metal element 4, for example, the male screw portion 41a of the bolt 41.

### Outline of Fiber Reinforced Resin Structure Manufacturing Method

Next, an outline of a method of manufacturing the fiber reinforced resin structure 1 according to the present Embodiment will be described. As shown in FIGS. 1 to 4, the manufacturing method relates to a method of manufacturing the fiber reinforced resin structure 1 having the through-hole 1a.

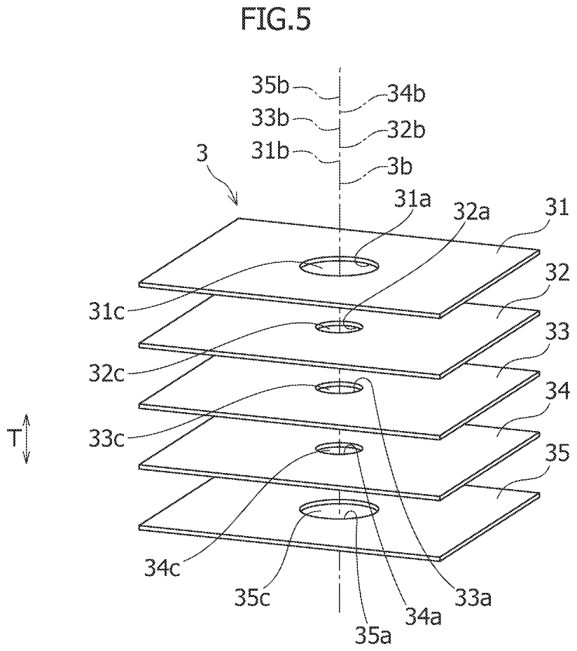

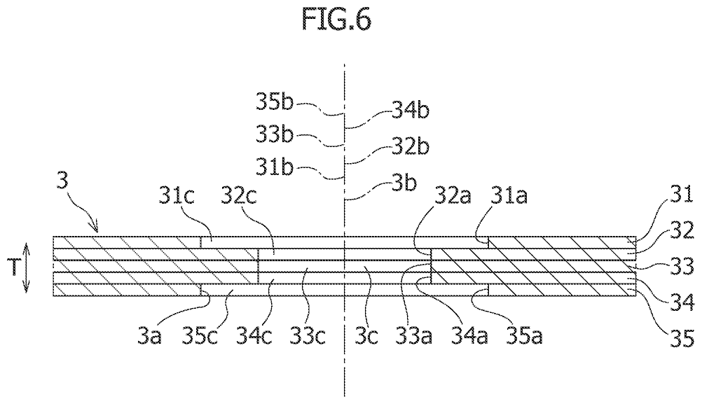

As shown in FIG. 5, the method of manufacturing the structure 1 includes a preparation step in which blanking is performed on each of the plurality of base material sheets 31 to 35 and during this blanking, temporary through-holes 31c to 35c are respectively formed in the plurality of base material sheets 31 to 35. As shown in FIG. 6, the method of manufacturing the structure 1 includes a stacking step in which the plurality of base material sheets 31 to 35 are stacked together such that the temporary through-holes 31c to 35c of the plurality of base material sheets 31 to 35 having thus undergone blanking, are continuous in the thickness direction of the structure 1.

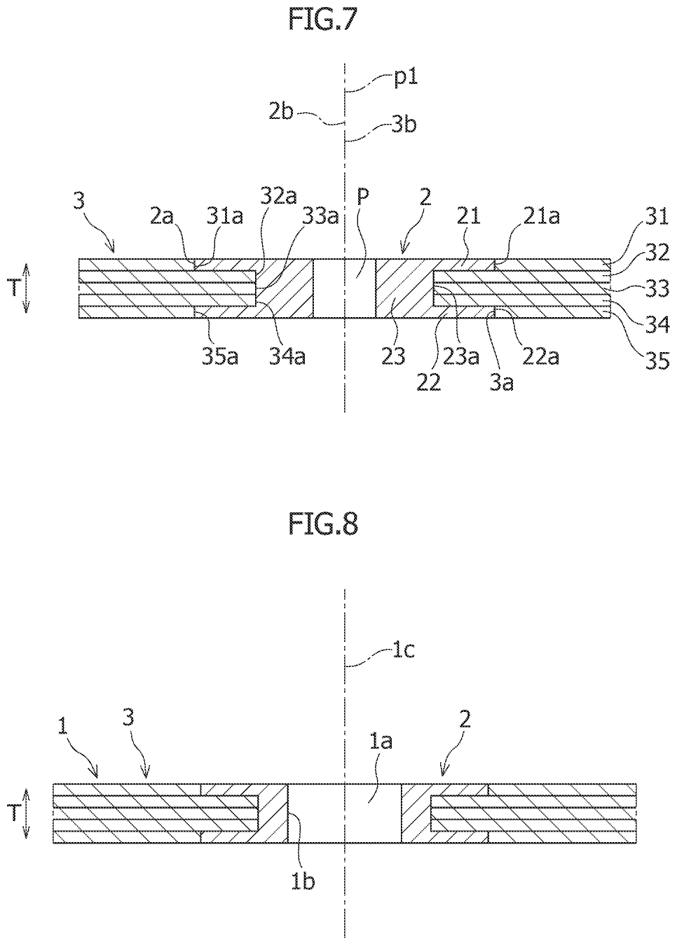

As shown in FIG. 7, the method of manufacturing the structure 1 includes a molding step in which molding is performed on the plurality of base material sheets 31 to 35 thus stacked together. In the molding step, the inner resin portion 2 formed of a matrix resin, is formed so as to cover the peripheral edges 31b to 35b of the temporary through-holes 31c to 35c of the plurality of base material sheets 31 to 35. As shown in FIG. 8, the method of manufacturing the structure 1 includes a hole shaping step in which the through-hole 1a is formed so as to extend through the inner resin portion 2 thus formed in the molding step. In the method of manufacturing the structure 1, the preparation step, the stacking step, the molding step, and the hole shaping step described above, are executed in that order, whereby the fiber reinforced resin structure 1 is manufactured.

Furthermore, the method of manufacturing the fiber reinforced resin structure 1 may be the following. As shown in FIG. 5, in the preparation step, the temporary through-holes 31c and 35c of two base material sheets 31 and 35 of the plurality of base material sheets 31 to 35 may be formed to be larger than the temporary through-holes 32c to 34c of the remaining base material sheets 32 to 34. As shown in FIG. 6, in this case, in the stacking step, these two base material sheets 31 and 35 may be respectively arranged at both ends in the thickness direction of the structure 1.

However, in the preparation step, it is also possible to form the temporary through-hole of one base material sheet of the plurality of base material sheets to be larger than the temporary through-holes of the remaining base material sheets. In this case, in the stacking step, this one base material sheet may be arranged at one end in the thickness direction of the structure.

### Details on Method of Manufacturing the Fiber Reinforced Resin Structure

In detail, the method of manufacturing the fiber reinforced resin structure 1 may be the following. Although not particularly shown clearly, in the blanking in the preparation step, the base material sheets 31 to 35 are cut so as to impart a desired outer shape to the structure 1. For example, the blanking and the machining for shaping the temporary through-holes 31c to 35c can be executed so as to cut each of the plurality of base material sheets 31 to 35 at one time by using a mold having a desired outer shape and a cutter edge portion corresponding to the temporary through-holes 31c to 35c.

In the preparation step, in the case in which the outer resin portion 3 has a plurality of intermediate base material sheets 32 to 34, these temporary through-holes 32c to 34c may be formed in a substantially the same size. As described above, in the case in which the temporary through-hole of solely one of the one and the other end side base material sheets is formed to be larger than the temporary through-holes of the intermediate base material sheets, it is also possible for the temporary through-hole of the other of the one and the other end side base material sheets to be formed in substantially the same size as the temporary through-holes of the intermediate base material sheets. Furthermore, in the case in which the outer resin portion has a plurality of intermediate base material sheets, the temporary through-hole of at least one intermediate base sheet material can be formed in a size different from that of the temporary through-hole of a different intermediate base material sheet.

As shown in FIG. 7, in the molding step, a preliminary through-hole P which is smaller than the through-hole 1a of the structure 1, is formed in the inner resin portion 2. The center axis p1 of the preliminary through-hole P may substantially coincide with the center axis 1c of the through-hole 1a. Furthermore, the center axis p1 of the preliminary through-hole P may substantially coincide with the center axis 2b of the inner resin portion 2. However, the center axis of the preliminary through-hole is not limited thereto. Furthermore, the molding step may be executed so as to form no such preliminary through-hole in the inner resin portion.

Although not particularly shown clearly, in the hole shaping step, the through-hole 1a is formed by performing drilling processing on the inner resin portion 2 by using a drilling tool, such as a drill or the like. In the drilling processing, the preliminary through-hole P can be used as a let-in hole for the drilling tool.

As described above, the fiber reinforced resin structure 1 of the present Embodiment has the inner resin portion 2 forming the peripheral edge portion 1b of the through-hole 1a thereof, and the outer resin portion 3 arranged so as to be adjacent to the outer peripheral edge 2a of the inner resin portion 2. The inner resin portion 2 is formed of a matrix resin, and the outer resin portion 3 includes a plurality of base material sheets 31 to 35 formed of a fiber reinforced resin having fiber and a matrix resin. The plurality of base material sheets 31 to 35 are stacked together in the thickness direction of the structure 1, and the inner side and outer resin portions 2 and 3 are formed integrally of the matrix resin so as to be continuous with each other.

Furthermore, the method of manufacturing the fiber reinforced resin structure 1 according to the present Embodiment includes: a stacking step in which a plurality of base material sheets 31 to 35 are stacked together such that the temporary through-holes 31c to 35c extending through the plurality of base material sheets 31 to 35, are continuous with each other in the thickness direction of the structure 1; a molding step in which the plurality of base material sheets 31 to 35 stacked together, are molded while forming the inner resin portion 2 so as to cover the peripheral edges of the temporary through-holes 31c to 35c of the plurality of base material sheets 31 to 35 stacked together; and a hole shaping step in which the through-hole 1a is formed so as extend through the inner resin portion 2.

In this structure, the hardness of the inner resin portion 2 formed of a matrix resin, is lower than the hardness of the outer resin portion 3 including the plurality of base material sheets 31 to 35 formed of a fiber reinforced resin having fiber and a matrix resin. Thus, in the hole shaping step, the through-hole 1a can be easily formed in the inner resin portion 2. Furthermore, the operation time for the hole shaping step can be reduced, and wear of the drilling tool for forming the through-hole 1a, such as a drill or the like, can be reduced. As a result, the through-hole 1a can be easily formed in the structure 1, and the manufacturing efficiency of the structure 1 having the through-hole 1a, can be improved. In addition, in this construction, the inner resin portion 2 including no fiber, and the outer resin portion 3 including fiber, are formed while clearly distinguished from each other. Thus, it is possible to suppress generation of stress concentration attributable to a change in the density of the fiber, and it is possible to efficiently suppress a reduction in the strength of the fiber reinforced resin structure 1.

In particular, even in the case in which the fiber reinforced resin of the structure 1 includes carbon fiber, the inner resin portion 2 formed of a matrix resin has the thickness direction contact region C1 coming into contact with the metal element 4 inserted into the through-hole 1a in the thickness direction of the structure 1, so that it is possible to efficiently prevent generation of electric erosion of the metal element 4 attributable to the contact between the structure 1 including carbon fiber and the metal element 4. Thus, it is possible to efficiently suppress a reduction in the strength of the structure 1 using the metal element 4.

In the preparation step of the method of manufacturing the fiber reinforced resin structure 1 according to the present Embodiment, it is possible to simultaneously perform blanking on the plurality of base material sheets 31 to 35 and the formation of the temporary through-holes 31c to 35c. Thus, the manufacturing efficiency of the structure 1 having the through-hole 1a, can be improved.

In the fiber reinforced resin structure 1 of the present Embodiment, the outer peripheral edge 21a and 22a of at least one of both end portions 21 and 22 of the inner resin portion 2 is formed to be larger than the outer peripheral edge 23a of the intermediate portion 23 of the inner resin portion 2.

In the method of manufacturing the fiber reinforced resin structure 1 of the present Embodiment, in the preparation step, the temporary through-hole 31c and 35c of one or two base material sheets of the plurality of base material sheets 31 to 35 is formed to be larger than the temporary through-holes 32c through 34c of the remaining base material sheets 32 to 34, and, in the stacking step, this one base material sheet 31c is arranged at one end in the thickness direction of the structure 1, or the two base material sheets 31c and 35c are respectively arranged at both ends in the thickness direction of the structure 1.

In this construction, in the case in which one end portion 21 of the inner resin portion 2 is formed to be larger than the intermediate portion 23 of the inner resin portion 2 and the metal element 4 has, for example, the bolt 41 as mentioned above, the one end portion 21 of the inner resin portion 2 comes into contact with the head portion 41b of the metal bolt 41 in the thickness direction of the structure 1. Furthermore, in the case in which one and the other end portions 21 and 22 of the inner resin portion 2 is formed to be larger than the intermediate portion 23 of the inner resin portion 2 and the metal element 4 has, for example, the metal plate 43 as mentioned above in addition to the bolt 41, the other end portion 22 of the inner resin portion 2 comes into contact with the metal plate 43 in the thickness direction of the structure 1. Thus, in particular, even in the case in which the fiber reinforced resin of the structure 1 includes carbon fiber, it is possible to efficiently prevent generation of electrical erosion of the metal element 4 attributable to the contact between the structure 1 including carbon fiber and the metal element 4. Thus, a reduction in the strength of the structure 1 using the metal element 4, can be suppressed.

Furthermore, the outer peripheral edge 23a of the intermediate portion 23 of the inner resin portion 2 is smaller than the outer peripheral edge 21a and 22a of at least one of both end portions 21 and 22 of the inner resin portion 2, whereas the outer resin portion 3 adjacent to the outer peripheral edge 23a of the intermediate portion 23 of this inner resin portion 2 can be formed large. The strength of this outer resin portion 3 is higher than the strength of the inner resin portion 2, so that strength at the intermediate portion in the thickness direction of the structure 1, can be improved.

Although the Embodiment of the present invention has been described above, the present invention is not limited to the aforementioned Embodiment but allows modification and alteration based on the technical concept thereof.

### REFERENCE SIGNS LIST

1 . . . Fiber reinforced resin structure (Structure), 1a . . . Through-hole, 1b . . . Peripheral edge portion
2 . . . Inner resin portion, 2a . . . Outer peripheral edge, 21 . . . One end portion (end portion), 21a . . . Outer peripheral edge, 22 . . . Other end portion (end portion), 22a . . . Outer peripheral edge, 23 . . . Intermediate portion, 23a . . . Outer peripheral edge
3 . . . Outer resin portion, 3c . . . Temporary through-hole, 31 to 35 . . . First to Fifth base material sheets, 31a to 35a . . . Inner peripheral edge (Peripheral edge), 31c to 35c . . . Temporary through-hole
4 . . . Metal element
C1 . . . Thickness direction contact region (Contact region)

1. A fiber reinforced resin structure having a through-hole, the fiber reinforced resin structure comprising:
an inner resin portion forming a peripheral edge portion of the through-hole; and
an outer resin portion arranged so as to be adjacent to an outer peripheral edge of the inner resin portion, wherein
the inner resin portion is formed by a matrix resin,
the outer resin portion includes a plurality of base material sheets formed of a fiber reinforced resin having fiber and the matrix resin,
the plurality of base material sheets are stacked together in a thickness direction of the fiber reinforced resin structure, and
the inner and outer resin portions are formed integrally so as to be continuous with each other by the matrix resin.

2. The fiber reinforced resin structure according to claim 1, wherein the inner resin portion has a contact region coming into contact with a metal element inserted into the through-hole in the thickness direction of the fiber reinforced resin structure.

3. The fiber reinforced resin structure according to claim 2, wherein the inner resin portion has both end portions respectively situated at both end portions in the thickness direction of the fiber reinforced resin structure, and an intermediate portion situated between both end portions of the inner resin portion in the thickness direction, and
the outer peripheral edge of at least one of both end portions of the inner resin portion is formed to be larger than the outer peripheral edge of the intermediate portion of the inner resin portion.

4. A method of manufacturing a fiber reinforced resin structure having a through-hole, the method comprising:
a stacking step of stacking together a plurality of base material sheets so as to make a temporary through-hole extending through the plurality of base material sheets continuous in a thickness direction of the fiber reinforced resin structure, the base material sheets being formed of a fiber reinforced resin having fiber and a matrix resin;
a molding step of molding the plurality of base material sheets stacked together, while forming an inner resin portion which covers a peripheral edge of the temporary through-hole of the plurality of base material sheets stacked together and is formed of the matrix resin; and
a hole shaping step of shaping the through-hole such that the through-hole extends through the inner resin portion.

5. The method according to claim 4, further comprising a preparation step in which blanking is performed on each of the plurality of base material sheets and the temporary through-hole is shaped at the time of the blanking, the preparation step being prior to the stacking step.

6. The method according to claim 5, wherein during the preparation step, the temporary through-hole of one or two base material sheets among the plurality of base material sheets is made larger than the temporary through-holes of the remaining base material sheets among the plurality of base material sheets, and
during the stacking step, the one base material sheet is arranged at one end in the thickness direction of the fiber reinforced resin structure, or the two base material sheets are respectively arranged at both ends in the thickness direction of the fiber reinforced resin structure.
